(19) United States
(12) Patent Application Publication
(10) Pub. No.: US 2008/0200144 A1
(43) Pub. Date: Aug. 21, 2008

(54) System and Method for Providing Alerts Over a Network

(76) Inventors: Todd D. Ginsberg, Austin, TX (US); Keith Sibson, Austin, TX (US)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/830,585

(22) Filed: Jul. 30, 2007

Related U.S. Application Data
(60) Provisional application No. 60/890,409, filed on Feb. 16, 2007.

(51) Int. Cl. H04M 11/00

(52) U.S. Cl. 455/407

(57) ABSTRACT

The present disclosure provides system and methods for providing real time alerts over a network. In one respect, transactional data including a card identifier is received by a transaction processor. At least one alert corresponding to the received transactional data may be determined and may be forwarded to a mobile unit associated with the card identifier. Alternatively or in addition, messages received by a card user may be received. At least one alert responsive to the received message may be determined and may be forwarded to a card user via a mobile unit.

### RELATED APPLICATION

This application claims priority to and incorporates by reference in its entirety U.S. Provisional Patent Application No. 60/890,409, filed Feb. 16, 2007 by Keith Sibson et al. and entitled “Netspend Alerts Platform.”

### TECHNICAL FIELD

The present disclosure relates to financial transactions, and more particularly, to a system and method for providing account information over a mobile unit in substantially real-time.

### BACKGROUND

Consumer-based transactions either at a point of sale, over the phone, or on the Internet generally involve cashless transactions. This includes transactions using debit cards, credit cards, check cards, prepaid debit or credit cards, and the like. Typically, a post-pay card (e.g., credit card) may be used to obtain goods and/or services. These cards generally include an identifier, such as an account number, that may be used by the merchant. The merchant may send a transaction amount via an electronic system to an issuing bank of the post-pay card requesting payment. The amount may be deducted from the card holder's credit limit. The issuing bank may subsequently bill the customer for the transaction amount at a later time.

Prepaid cards are cards that include a predetermined amount purchased prior to the commencement of any transaction. When a consumer buys goods or services, the transaction amount is deducted from the predetermined amount. This may be accomplished, for example, using an existing banking network. When the prepaid card is used, the transaction amount may be routed to the appropriate destination and the value of the predetermined amount may be decremented accordingly.

Current techniques for tracking and monitoring usage by post-pay cards and prepaid cards include monthly statements or web-based applications whereby a user can review usage. However, account information, such as an available balance or a credit limit, may affect a transaction (e.g., authorization of a transaction or declining a transaction at a point of sale based on an available balance), and therefore, an up-to-date, real-time account status is needed.

### SUMMARY

The present disclosure provides, real-time account information to a mobile unit. In one respect, a method is provided. The method includes steps for receiving as input transactional data including a card identifier from a point of sale. At least one device alert corresponding to the received transactional data may be determined and subsequently forwarded to a mobile unit associated with the card identifier.

The method may also include steps for forwarding an alert to a mobile unit that is responsive to an inquiry by a card user. In one respect, a card (e.g., prepaid or post-pay card) may be registered with an alert system. The alert system may receive a message from the user of the card. Based on the message, an alert may be determined and may be forwarded to a mobile unit associated with the registered card.

In other respects, an alert system may be provided. The system may include a transaction processor coupled to an outgoing alert server. The transaction processor may be operable configured to receive transactional data including a card identifier, determine an alert associated with the data, queue the alert for distribution. The outgoing processor may be configured to forward the alert to a mobile unit associated with the card identifier.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a system for delivering alerts in accordance with embodiments of the present disclosure;

FIG. 2 illustrates a flowchart of a method for forwarding alerts to a mobile unit in accordance with embodiments of the present disclosure;

FIG. 3 illustrates a step for determining if a card is registered with an alert system in accordance with embodiments of the present disclosure;

FIG. 4 illustrates a system for sending delivery alerts using a SMS over SMPP method in accordance with embodiments of the present disclosure;

FIG. 5 illustrates a system for sending delivery alerts using an email over SMTP method in accordance with embodiments of the present disclosure;

FIG. 6 illustrates a system for sending delivery alerts using a SMS over SMTP method in accordance with embodiments of the present disclosure; and

FIG. 7 illustrates a flowchart of a method for forwarding alerts to a mobile unit in accordance with embodiments of the present disclosure.

FIGS. 8A and 8B illustrate examples of tag lines in accordance with embodiments of the present disclosure.

### DETAILED DESCRIPTION

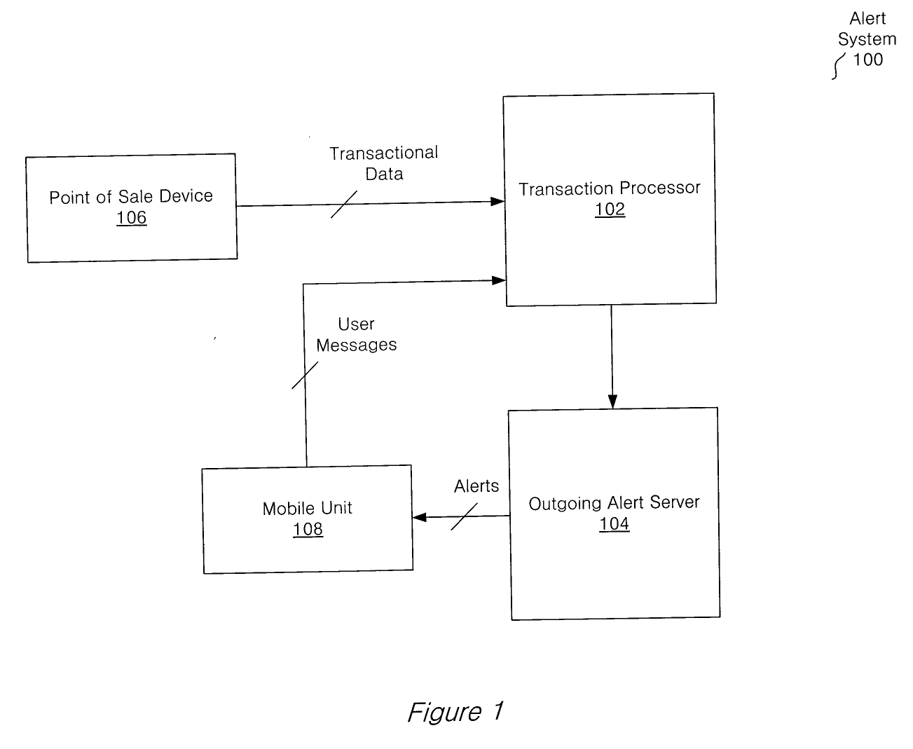

Preferred embodiments and their advantages are best understood by reference to FIGS. 1 through 6, wherein like numbers are used to indicate like and corresponding parts.

The present disclosure provides, among other advantages, systems and methods for substantially real-time account information delivered to mobile units including, but not limited to, mobile phones, PDAs, pocket computers, pagers, and other wireless units. In one respect, the system may support one-way mobile terminated (MT) alerts to provide card users the status of their card. Examples of MT alerts include balance notification, transaction alerts, and other account information may be provided.

Alternatively or in addition, the systems and methods of the present disclosure may provide a two-way mobile originated (MO) alert. A card user may send a text message from a mobile unit to a system requesting information about a prepaid or post-pay card. The requested information may subsequently be provided to the mobile unit.

In one respect, a card user may enroll a prepaid and/or post-pay card to an alert messaging service via a website, an automated phone system, at a bank issuing the card, through a customer service agent over a phone system, or at a location where a prepaid card may be purchased. The card user may provide a phone number, a media access control (MAC) address, or other mobile unit identifiers that may be recorded and associated with the card being enrolled. In one respect, the system network may send a text message to the mobile unit to verify the recorded mobile unit identifier is accurate.

It is noted that more than one mobile unit may be recorded and associated with one card. For example, if a card has multiple users, the system network may record and associate the card to one or more mobile units for each user. The system network may subsequently provide alerts to each mobile unit associated with a card accordingly. For example, alerts related to a card may be sent to each user's mobile unit including multiple similar mobile units (e.g., multiple cell phones) or multiple different mobile units (e.g., a cell phone and a PDA).

Referring to FIG. 1, a system network for sending alerts is shown. Alert system 100 may include a transaction processor 102 coupled to outgoing alert server 104. Transaction processor 102 may receive information (e.g., merchant information, transaction amount, card identifier, etc.) from point of sale device 106 regarding a transaction and may determine if the transaction triggers an alert that may need to be sent by outgoing alert server 104 to mobile unit 108. For example, in one embodiment, an activity alert may be sent based on information received by transaction processor 104. In one respect, activity alerts may be triggered based on account transaction activity. For example, activities such as signature or personal identification number (PIN) purchases at a merchant, ATM cash withdrawals, instant transfers between accounts, direct deposit loads, cash loads to a prepaid card, transfers between savings and primary accounts, and/or fee based debits may be received by transaction processor 102 and may trigger a real-time alert sent by outgoing alert server 104 to the card user via a card user's mobile unit. The alert may be a text based message including, without limitation, the transaction amount, and the remaining balance or current available balance on the card.

Alternatively or in addition to the activity alerts, alert system 100 may send educational alerts. In one embodiment, education alerts may be triggered similarly as the alert activities but may provide more detail than the activity alert. Educational alerts may be sent to curtail a card user's confusion and may preempt calls made to a customer service agent, thus reducing calls to a call center and increasing customer satisfaction

A non-limiting example of an educational alert involves a card user's transaction at a gasoline pump. A pay-at-the-pump alert may be sent to a mobile unit of a card user who is using the card at a pump for the first time. The educational alert may inform the card user that the merchant may pre-authorize an amount that is greater than the transaction amount, e.g., the amount paid for gasoline. The educational alert may also inform the card user that the pre-authorize amount may be later adjusted and the difference in the pricing may be “released” and available for future transaction.

Another example of an educational alert includes explanation of why a transaction may have been declined at the point of sale. Generally, a large volume of calls to customer services are a result of not knowing why a transaction was declined. To curtail this, alert system 100 may send an alert to a card user once a transaction is declined explaining the reason (e.g., insufficient funds, a block on the card user's account, etc.).

Alert system 100 may also provide a fee-plan alert for a card user whose card has a fee-plan that expires after a period of time. For example, a card may have a period for free transactions and the fee-plan alert warns the card user that the period is about to expire and to expect certain fees associated with future transactions.

Another example of an alert includes a gratuity alert that may be sent to a card user if he/she is at a merchant that typically adds a percentage to the pre-authorized funds in order to cover an expected tip. For example, some restaurants and bars add a certain percentage to the bill amount for gratuity purposes. Regardless of whether the transaction is approved or not, the card user may receive an alert that notifies him/her of the charges. In some embodiments, such alerts may be communicated for first time consumers at the merchant.

Similarly, transaction processor 102 may send out periodic alerts. For example, information regarding a daily balance, weekly balance, grace-period balance, monthly balance, or similar balances, credit limits, minimum payment due, and/or interest accrual may be sent to a card user as a regular update.

In some embodiments, alert system 100 may implement a “back-off” policy which limits the amount of periodic alerts sent to a card user. For example, if a zero-balance is maintained over a certain amount of time, alert system 100 may send a limited number of alerts up until a threshold is met. After the threshold is met, alert system 100 may cease broadcasting the alerts until the account balance is above or below zero again.

Similarly, alert system may implement a “blackout window” in which the delivery of alerts are suspended, unless provoked by a card user. For example, a time period spanning between certain hours of the night (e.g., 11 pm to 8 am), some or all alerts may be queued and are not delivered until the blackout window has expired. Certain alerts, such as alerts responding to messages received by the card user during the blackout windows, may still be forwarded by the alert system.

It is noted that a card user may customize and configure the type and the number of alerts sent by the system network. The configuration may be done prior to or after enrollment of the card and may be based on configured when a specific condition or transaction occurs. For example, the card user may configure the alerts to be sent when the card balance is below a certain dollar amount or when a transaction exceeds a certain dollar amount.

The activity alert, educational alert, fee-plan alert, gratuity alert, and periodic alerts are examples of a one-way mobile terminated alerts, or “MT alerts,” sent by alert system 100. In some embodiments, an alert may be triggered when a card user sends a text message to a server via email or a text message to a “short code,” typically a five digit number that serves as an address within a mobile telephone system. This is typically referred to in the industry as a two-way mobile originated (MO) interface. When a user sends a message to the short code, the SMS aggregator receives the message and subsequently forwards the message to the system. The message sent by the card user may include the number of the mobile unit sending the message, the mobile carrier the card user is on, and the text of the message being sent.

Upon receiving the message from the card user, alert system 100 may also send “MO alerts”, or alerts triggered by a card user's request. In one respect, a MO alert may be configured by the card user when a specific condition or transaction occurs. For example, the card user may configure the alerts to be sent when the card balance is below a certain dollar amount or when a transaction exceeds a certain dollar amount.

Another example of an MO alert may be a help alert. A card user may send a message via, for example, SMS. Transaction processor 102 may search for keywords in the message and may reply to the message. For example, if a card user types “My card is stolen, what do I do?”, transaction processor may parse out the word “stolen” and may send instructions on how to report the stolen card, including, for example, a customer service number.

Alternatively, a list of keywords may be provided to a card user at issuance to help aid the card user when sending in questions or concerns. These keywords may include balance request (BAL), terminating alert messages (STOP), etc. The message and/or keywords provided by the card user may be logged, compared with regular expressions, and may subsequently be associated with an alert. The appropriate alert may be generated, queued, and forwarded to the mobile unit with which the card user sent the message. Alternatively, the alert message may be sent to any mobile units associated with the card.

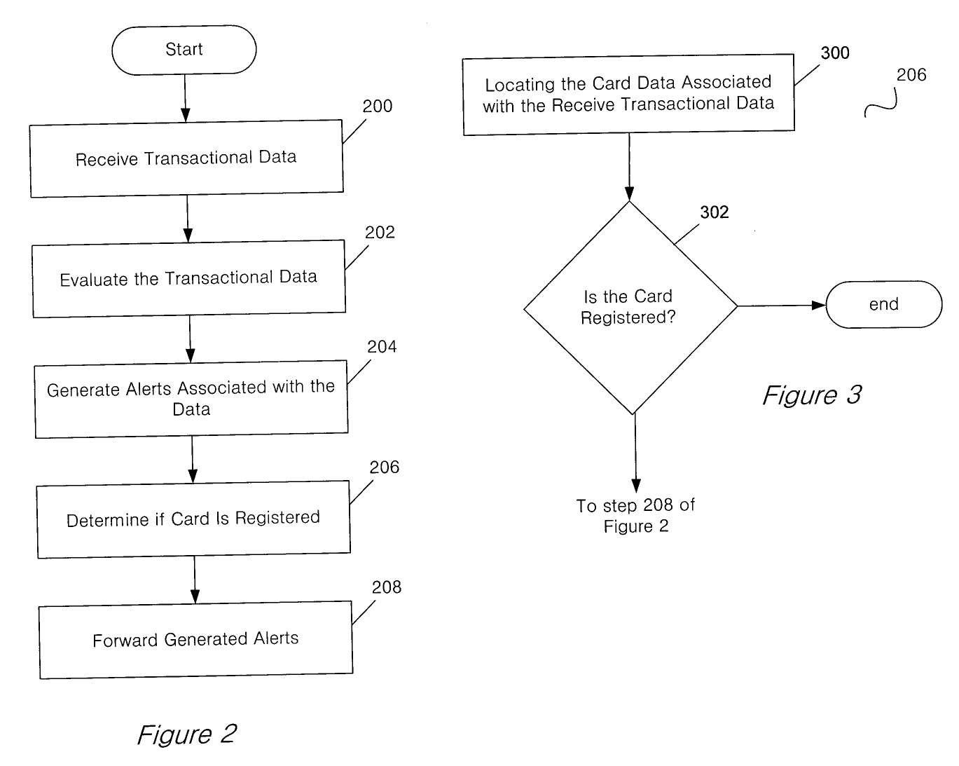

There are various techniques that may be used to submit the alerts generated in transaction processor 102. In one respect, referring to FIG. 2, a flow chart for forwarding alerts to a mobile unit is shown. In step 202, transactional data may be received by, for example, a transaction processor. The transactional data that may be received by a transaction processor includes, without limitation, data from a point of sale (PoS) including a retail shop, a service provider, a phone order, or an Internet order. The PoS data may include merchant information, transaction amount, and/or card identifier. Alternatively, the transactional data may include a message sent by a card user to the transaction processor.

Next, in step 202, the data received by the transaction processor may be evaluated. In one respect, the transaction processor may process the transaction to determine if the data received may trigger an alert. For example, merchant data may trigger an activity alert, an educational alert, and/or a gratuity alert. Similarly, the transaction amount data may trigger an activity alert, a balance alert, and/or educational alert. The transaction processor may subsequently generate applicable alerts that may be useful to the card user (step 204).

In other respects, the transactional data received may be a request or question from the card user. The data may be evaluated to determine what information and or alert may be passed along to the user as a response. For example, a card user may be trying to locate a merchant and may send data requesting, for example, location information, hours of operation, and a phone number. The transaction processor may generate applicable alerts as well as other general information that may be useful to the card user (204).

The alerts generated may be delivered real-time in subsequent steps shown in FIG. 2. In some embodiments, alerts may be queued in a storage means (random access memory (RAM), electronically erasable programmable read-only memory (EEPROM), a PCMCIA card, flash memory, or any suitable selection and/or array of volatile or non-volatile memory) and may be tracked by transaction processor 102. Certain alerts such as educational alerts, gratuity alerts, fee-pay alert and others may be pre-generated and may be called from memory when a transactional data received in step 200 corresponds with one of the alerts. Alternatively, alerts such as periodic alerts may be pre-generated and stored for later forwarding.

For alerts being stored, transaction processor 102 may provide certain properties to identify the stored alert. For example, the alert may include a unique ID, the type of the alert, mobile unit carrier information, and/or the mobile unit identifier (e.g., phone number, MAC address, email address) where the alert are to be delivered. Transaction processor 102 may also store tracking properties with the alert. For example, information including the priority of the alert, time for delivery, and/or a number of delivery attempts may be used to track when an alert is forwarded to a card user.

It is noted that the above examples of the type of data received in step 200, the evaluation of the received data in step 202, and generation of alerts based on the evaluation of the received data in step 204 may vary depending on the type of cards, type of information received, and the type of alerts available in the system. One of ordinary skill in the art can recognize that various other data may be received and one or more alerts may be generated based on the data.

In step 206, transaction processor 102 may determine if the card relating to the transactional data is registered with an alert system. Referring to FIG. 3, a detailed flowchart of step 206 is shown. In one respect, the transactional data may include a card identifier or account number. The transaction processor may determine if a mobile unit identifier (e.g., a mobile unit phone number, a MAC address, etc.) has been recorded as shown in step 300. At step 302, if the mobile unit identifier is not recorded, no alerts or message may be sent to the card user. If a mobile unit identifier has been recorded, the generated results may be forwarded to the mobile unit associated with the recorded mobile unit as shown in step 208 of FIG. 2.

Step 208 may include various delivery methods including, without limitation, a sending text message (e.g., SMS) over a short message peer to peer (SMPP) infrastructure, electronic mail (email) over SMTP technique, a SMS over SMTP technique, or other transferring schemes used to transmit a text alert to a wired or wireless mobile unit.

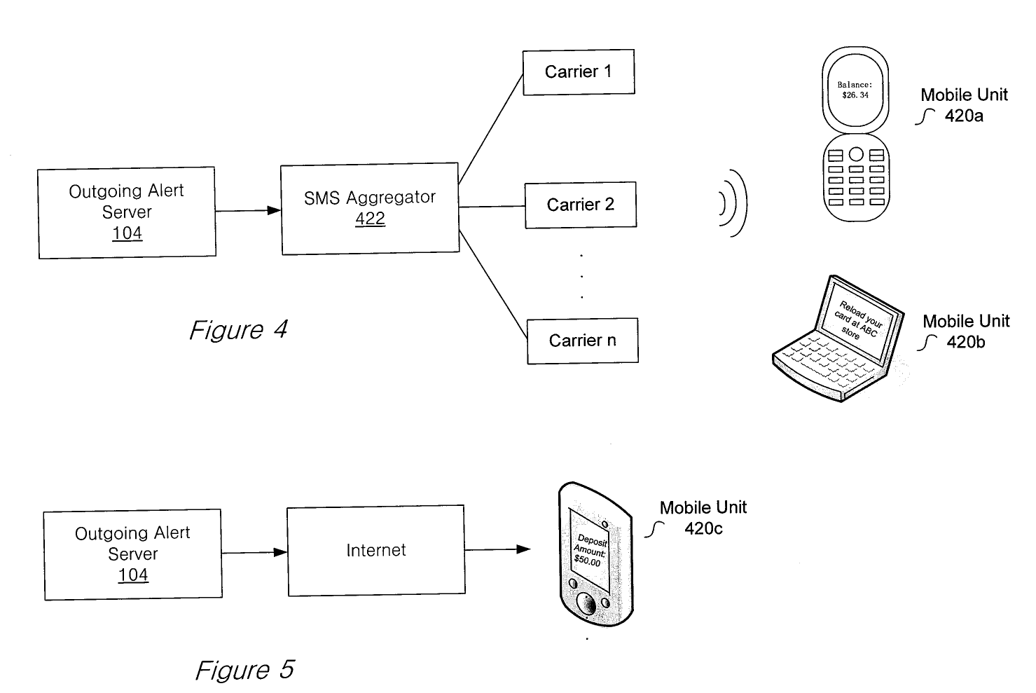

Referring to FIG. 4, a system for forwarding an alert to mobile units 420a or 420b is shown. Outgoing alert server 104 may interoperate with a plurality of mobile service operators (or carriers) through SMS aggregator 422. The SMS aggregator may connect with various carriers who may be able to forward the alert to the mobile units.

Using SMS over SMPP may provide many advantages. The technique provides monitoring over time, which enhances the system to ensure accuracy and timely alert delivery. Another benefit of the SMS over SMPP technique is the resolving of the portability issues by the aggregator. A card user may be in remote error with limited phone service and may be ‘roaming’ in another carrier's coverage area. By aggregating the connections, the carrier's mobile unit may be accessed.

In other embodiments, step 208 may deliver alerts using an email over a simple mail transfer protocol (SMTP) technique, as shown in FIG. 5. Server 104 may generate an email with the alert and may send the email over the internet to mobile unit 402c.

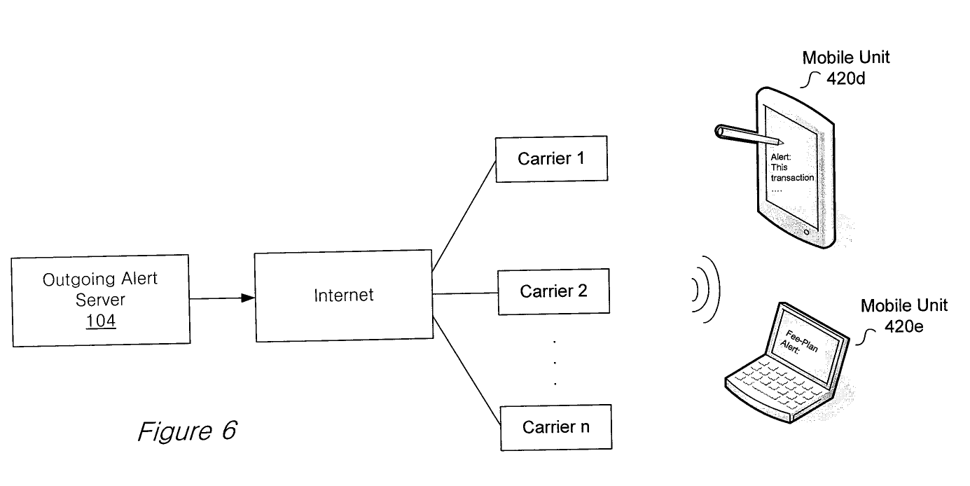

Alternatively, referring to FIG. 6, a SMS over SMTP technique may be used to deliver alerts. Outgoing alert server 104 may utilize a mobile operator's SMTP gateway or the Internet to deliver a SMS message to mobile units 420d or 420e.

It is noted that the systems for delivering alerts shown in FIGS. 5 and 6 may be used either separately, or in combination. When more than one mobile units have been registered for a particular card, one or more of the systems shown may be used to effectively and efficiently send alerts. For example, if one of the mobile units is a cell phone and the other mobile unit is a portable computer (wired or wirelessly connected to the Internet), a SMS message over SMPP and email over SMTP may be used.

Step 208 may involve transaction processor 102 which may be responsible for sending real-time alerts based on transactional data and queued alerts that may be generated in step 204 and subsequently stored for later forwarding, and in some embodiments, at an appropriate time (e.g., periodic alerts). Transaction processor 102 may maintain contact with the memory storing alerts, the SMS aggregator, and the SMTP gateway to ensure alerts according to priority and at an appointed time if necessary.

In some respects, transaction processor 102 may check memory to determine if there are alerts that may need to be forwarded. A batch of alerts may be ordered according to priority. The batch may be set number of alerts (e.g., 1000 alerts, 10,000 alerts, etc.) or may be any random number of alerts may be ordered for sending.

Due to the nature of the sending of the alert to a specific card user, transaction processor 102 may include tag lines that may append to outgoing alerts or tag lines that may be sent as a separate alert to a card user. A tag line, as defined and used herein, refers to a short message appended to or separate from an alert that includes information that supplement or is distinct from the alerts and may fill available space in the alert. Examples of tag lines include, without limitation, branding of a merchandise, rebate information, discount information, contest information, service providers information, location information, and the like. A tag lines may be generated based on the transactional data received by the transaction processor. For example, transaction processor 102 may further customize the alert with information of a brand including, for example, brand name, brand website, phone number, and/or email addresses, and the name of the alert featured for the brand.

In addition or alternatively, the tag lines may be generated based on geography, the card user's demographics (e.g., age, sex, etc.), the card type (e.g., retail prepaid card, a branded credit card, a rewards card, etc.), and/or other similar information that may be collected at the time of registration. The card user may also provide information regarding interests in certain tag lines.

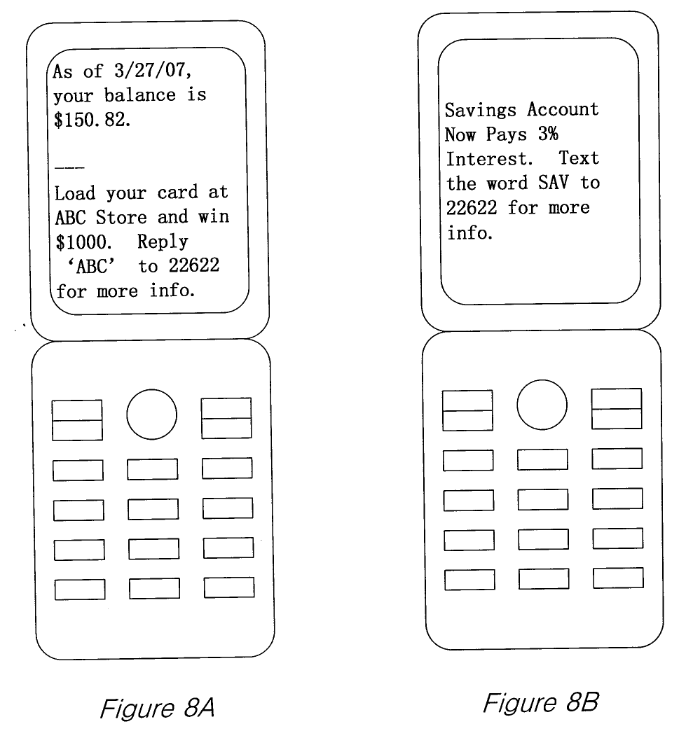

In some embodiments, referring to FIG. 8A, the tag lines may be dynamically appended to an outbound alert forwarded by an alert system. Alternatively, referring to FIG. 8B, the tag lines may be sent a user in a separate message.

Transaction processor 102 may also request status messages to determine the success of an alert being sent to a card user. The status messages may be aggregated over a time period such as every few days to every few months. For example, to ensure a status message is received once a month for a specific mobile unit, the following formula applies:

day_of_month=(mobileunitidentifier mod #ofdaysinmonth)+1 Eq. 1.

For example, if the mobileunitidentifier is the last two digits of the mobile unit's phone number (e.g., 555.555.5586) and the #ofdaysinmonth is 31 days, the day_of_month in which a status message is collected will be

(86 mod 31)+1=25

or the 25th of every month.

Alternatively, a status message may be generated after a predetermined amount of time. For example, the transaction processor may retrieve the status of a message after a certain amount of days, weeks, etc.

In some embodiments, the status message may be generated by the SMS or SMTP aggregator. Generally, these protocols include the delivery status of an alert sent over the course of any day. An FTP server may store the reports during delivery and using a batch process, the reports may be retrieved, parsed, and processed.

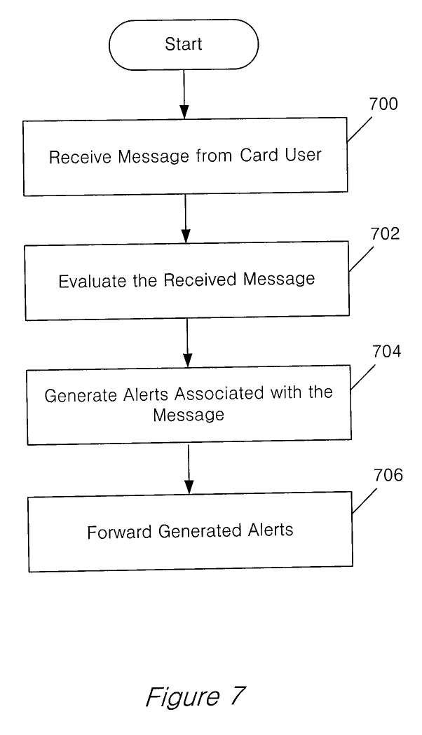

Some or all of the steps shown in FIG. 2 may be used to send alerts in response to messages sent from a card user. Referring to FIG. 7, in step 700, a message from a card user may be received, generally by a transaction processor. Various protocols including SMTP or SMS may be used to transmit the message from the card user to the alert system. The message may be an email, a text message and may include, without limitation, questions relating to account information (e.g., balance inquiry, deposits, withdrawals, payment due date, nearest payment location, information relating to a transaction, etc.), frequently asked questions (e.g., customer support numbers or contact information, where to reload a prepaid card, directions to nearest retailer, lost card information, etc.), configuration of alerts (e.g., frequency of alerts to send to mobile unit, types of alerts to send, etc.), update account information (e.g., new mobile unit information, registering of a card), and the like.

In step 702, a transaction processor may evaluate the received message. In some embodiments, the transaction processor may parse for keywords. Alternatively or in addition, the message may be manually reviewed.

Depending on the type of message was received, alerts associated with the message may be generated in step 704 and may subsequently be forwarded to the card user in step 706, using techniques shown, for example, in FIGS. 4 through 6. In one embodiment, the alerts may be forwarded to the mobile unit used to generate the message that was received in step 700.

Although the present disclosure has been described in detail, it should be understood that various changes, substitutions, and alterations can be made hereto without departing from the spirit and the scope of the invention as defined by the appended claims.

What is claimed is:

1. A method comprising:
receiving as input transactional data including a card identifier from a point of sale;
determining at least one device alert corresponding to the received transactional data; and
forwarding the at least one alert to a mobile unit associated with the card identifier.

2. The method of claim 1, wherein the transactional data further comprises merchant information and a transaction amount.

3. The method of claim 1, the mobile unit comprising at least one of a cell phone, a PDA, a pocket computer, and a pager.

4. The method of claim 1, wherein forwarding the at least one alert comprises forwarding an activity alert including a transaction amount and a balance.

5. The method of claim 1, wherein forwarding the at least one alert comprises forwarding an educational alert including information related to the transactional data.

6. The method of claim 5, wherein the information related to the transactional data comprises at least one of merchant information, a decline alert, and a gratuity alert.

7. The method of claim 1, wherein the card identifier identifies at least one of a post-pay card and a prepaid card.

8. The method of claim 1, wherein forwarding the at least one alert comprises forwarding a tag line and at least one alert.

9. The method of claim 1, further comprising:
receiving as input a message from a user via the mobile unit;
determining at least one alert corresponding to the message from the user; and
forwarding the one or more alerts corresponding to the message to the mobile unit.

10. The method of claim 1, wherein forwarding the at least one alert comprises sending a text message via a short message service (SMS) over a short message peer to peer (SMPP) infrastructure to a mobile cellular phone.

11. The method of claim 1, wherein forwarding the at least one alert comprises sending electronic mail over a simple mail transfer protocol (SMTP) to at least one of a PDA, portable computer, and a stationary computer.

12. The method of claim 1, wherein forwarding the at least one alert comprises sending a text message via a short message service (SMS) over a simple mail transfer protocol (SMTP) to a mobile cellular phone.

13. The method of claim 1, further comprising receiving a status message of the forwarding step at a predetermined time interval.

14. A method for providing real-time account information, the method comprising:
registering a card with an alert system;
receiving at the alert system a message from a user of the card;
determining an alert associated with the received message; and
forwarding the alert to a mobile unit associated with the registered card.

15. The method of claim 14, wherein receiving comprises receiving a text message from the user, the text message comprising account information, frequently asked questions, and configuration information.

16. The method of claim 14, wherein determining an alert comprises determining a key word in the message.

17. The method of claim 14, wherein forwarding the alert comprises forwarding a tag line and the alert.

18. The method of claim 14, further comprising:
receiving transactional data from a point of sale including an identifier of the card;
determining an alert associated with the transactional data; and
forwarding the alert to the mobile unit associated with the registered card.

19. A system comprising:
a transaction processor operable to: receive transactional data including a card identifier, determine an alert associated with the data;
queue the alert for distribution; and
an outgoing alert server coupled to the transaction processor, the server operable to forward the alert to a mobile unit associated with the card identifier.

20. The system of claim 19, wherein the transaction processor is further operable to:
receive a message from a card user; and
determining an alert associated with the received message.

21. The system of claim 19, wherein the outgoing alert server is further operable to forward the alert associated with the received message to the card user.

22. The system of claim 19, wherein the outgoing alert server is in operable connection to a short message service aggregator or the Internet.

23. The system of claim 19, wherein the outgoing alert server is operable to forward a tagline with the alert to the mobile unit.
